(19) United States
(12) Patent Application Publication
(10) Pub. No.: US 2006/0242840 A1
(43) Pub. Date: Nov. 2, 2006

(54) Wire end insert 66 tool with replaceable cutting blade

(76) Inventor: Robert W. Sullivan, Simi Valley, CA (US)

Correspondence Address: GENE W. ARANT, P.O. BOX 269, LINCOLN CITY, OR, 97367-0269, US

(21) Appl. No.: 11/117,049

(22) Filed: Apr. 29, 2005

(51) Int. Cl. B26B 3/00

(52) U.S. Cl. 30/142

(57) ABSTRACT

A wire termination tool for terminating conductor wires in a connector panel of the insulation displacing type has a cast metal tool body, or metal injected molded or other injected molded tool body, and a separate and replaceable cutting blade preferably made of a good grade of tool grade steel which is attached to the tool body at two different points along the length of the blade.

### PRIORITY CLAIM—RELATED APPLICATIONS

This application claims priority of my copending U.S. patent application Ser. No. 10/836,508 filed Apr. 29, 2004 as well as my U.S. Provisional Application Ser. No. 60/514,047 filed Oct. 24, 2003, the priority of which is also claimed in Ser. No. 10,836,508.

### FIELD OF THE INVENTION

The field of this invention is tools for wiring telephone and data circuits or the like.

### BACKGROUND OF THE INVENTION

Insulation displacing type connectors mounted in and part of a circuit board were introduced several decades ago and are commonly used in terminating telephone or high-speed data wires. An insulated end portion of each wire is forced between a pair of knife blades of an associated connector. A hand piece applies an impact force to a tool body which in turn forces the wire between the connector blades.

Forcing the wire into the connector causes the knife blades to cut into the insulating cover of the wire, so that there is then an electrically conductive engagememnt of the wire with the connector blades. Remnants of the insulation surrounding the contact area are purposely left in place so as to protect the contacts against moisture and/or corrosion. When the wire end is properly seated between the connector blades it is then also necessary to cut off a protruding end portion of the insulated wire. That operation is performed concurrently by forcing the wire between the contacts, with a blade edge carried on the forward end of the tool body.

One standard circuit board having insulation displacing type connectors is known as a “110 Block”. A tool for use with that type of circuit board is known as a “110 Blade”, and has a forward end portion with a U-shaped opening to partially encircle the end of the wire while forcing the wire between the knife blade contacts of the insulation displacing connector. During operation of a “110 Blade” tool the U-shaped opening is parallel to the common plane of the conductive knife blade contacts, but is perpendicular to the longitudinal axis of the wire being inserted into the connector. That type of tool also has a cutting edge extending perpendicular to the U-shaped opening in the forward end portion of the tool, for cutting off an end portion of the conductor wire as it is being secured to the connector block. A 110 Tool with replaceable cutting blade is disclosed and claimed in my copending application Ser. No. 10/836,508 filed Apr. 29, 2004.

Another standard circuit board with insulation displacing type connectors is known as a “66 Block”. A tool for use with that type of circuit board is known as a “66 Blade”. The forward end of the tool body has an essentially planar locator opening that receives and surrounds a pair of knife blade contacts of the connector block whose plane is then common to the plane of the opening. The conductor which is to be inserted between the blades of the connector block is placed across the forward end of the tool body, perpendicular to the locator opening. With forward movement of the tool body the conductor is forced between the knife blades of the connector while at the same time the blades are confined and squeezed by the locator opening of the tool body.

The 110 Blade tool is sometimes referred to as having a male tool type of action while the 66 Blade tool is sometimes referred to as having a female type of tool action.

### PRIOR ART

A 66 Blade type tool is shown in the Mason patent No. 03883.31-6 in which the tool body and cutting blade for cutting off the protruding end portion of the conductor are made as an integral member to perform both the positioning and wire cutting operations.

A 110 Blade type of tool is shown in U.S. Pat. No. 4,161,061 to Mason et al issued July 17, 1979. The tool body including a cutting blade for cutting off the protruding end portion of the conductor is made as an integral member to perform both the positioning and wire cutting operations.

Tool bodies for both 110 type tools and 66 type tools have typically been made as an integral steel casting including both the wire positioning end and the wire cutting end portion and blade, which is then machined, heat treated, and ground. Experience has shown that such tool bodies used in the impact type of tool system frequently have to be discarded because of wear and/or damage to the cutting edge of the blade. Experience has also shown that a dull or damaged cutting edge requires a high level of force which may then cause damage to the circuit board, or a bad wire connection.

Another example of prior art is shown in U.S. Pat. No. 6,615,480 issued Sep. 9, 2003 to Murphy, relating to both 110 Blade tools and 66 Blade tools. According to that patent a blade that performs the wire cutting operations is formed as a separate member and is then permanently attached to its supporting tool body by ultrasonic welding, insert molding, riveting, or gluing. When the blade becomes worn the entire tool would presumably be thrown away.

### SUMMARY OF THE INVENTION

According to my invention a separate and replaceable cutting blade is removably attached to a supporting cast tool body. In my WIRE END INSERT 66 TOOL WITH REPLACEABLE CUTTING BLADE a cast metal or metal injected molded, or other injected molded tool body, is used to position the end of an insulated wire between the knife blade contacts of an insulation displacing type of connector terminal. The tool body also has an elongated flat surface for receiving and supporting a replaceable cutting blade, and at its forward end has an essentially planar locator opening to receive and surround a pair of knife blade connector contacts whose plane is then common to the plane of the locator opening.

An important feature of my invention is that the replaceable cutting blade is made from a material that is able to provide a sharper cutting edge, and therefore achieves a sharper and cleaner cut on the end of the insulated wire being terminated. Another important feature of my invention is that the replaceable cutting blade accommodates for the ease of grinding for different cutting blade configurations. My replaceable cutting blade is preferably made of a good grade of tool grade steel. This cutting action reduces the force required to cut the insulated wire, resulting in less damage to the circuit board to which the connector is being attached. The tool body need not be heat treated or have a secondary grinding operation.

Further in accordance with the presently preferred embodiment of my invention I attach the removable blade to the tool body at two different points along the length of the blade. This is preferably accomplished by using a fastening screw near the rearward end of the blade and a locator/positioning pin near its forward end.

An advantage of my invention is that the cutting blade may be replaced without having to replace the tool body with which the blade is used. A technician working in the field can carry smaller replacement blades instead of the larger and heavier tool bodies, and does not have to carry complete replacement tools. The smaller blades can also be made readily available, which results in a considerable saving.

The presently illustrated preferred form of my invention is primarily intended for use in tool systems of the impact type; that is, tool systems including a hand piece to generate an impact that is imparted to the tool body. However, it is also feasible to use this new invention by way of a screwdriver type arrangement, with a blade set on the end of a screwdriver type mechanism and the force being imparted directly by the technician.

### DRAWING SUMMARY

FIG. 1 is a perspective view of the presently preferred form of my new WIRE END INSERT 66 TOOL WITH REPLACEABLE CUTTING BLADE, showing the replaceable blade in an offset position;

FIG. 2 is a longitudinal side elevational view of my new tool with the blade in its assembled position, and also showing an end elevation view;

FIG. 3 is a top plan elevational view of my new tool with the blade in its assembled position, and also showing an end elevation view;

FIG. 4 is a front elevation view of a pair of knife blade contacts of a connector panel, also showing above it the wire-engaging end of my new tool, and a conductor wire that is about to be fastened to the connector; and

FIG. 5 is a top plan view of an alternate form of removable cutting blade in accordance with my invention, in which its cutting edge has been fashioned with both a major cut and a minor cut on respective sides of the blade.

### DESCRIPTION OF PREFERRED EMBODIMENT

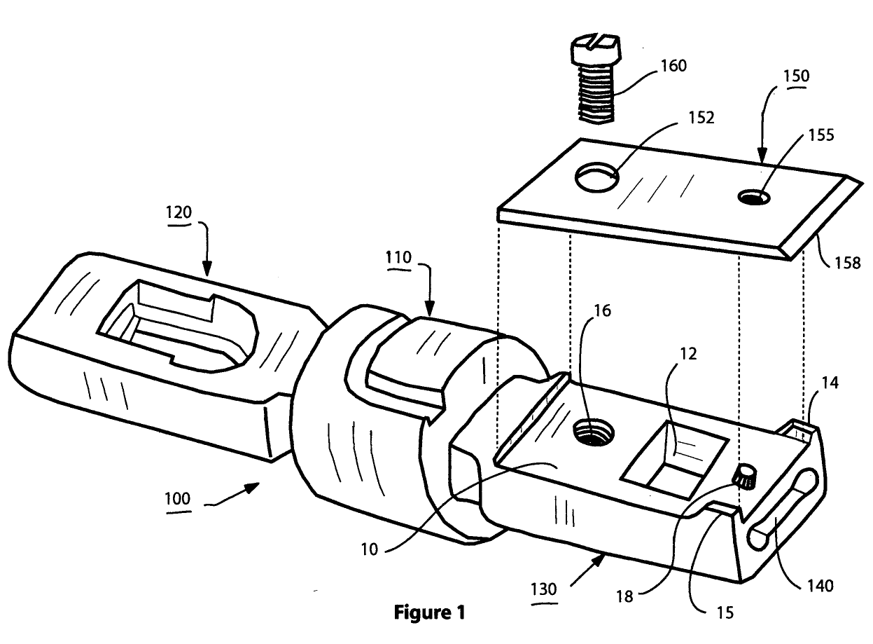

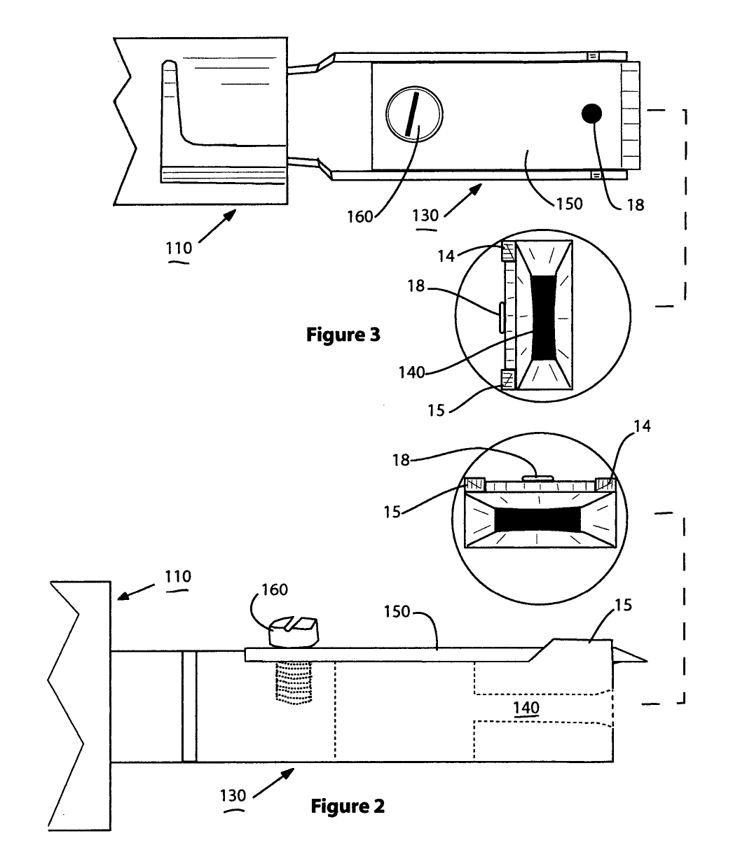

### (FIGS. 1-4)

Referring now to FIGS. 1 through 4 showing the preferred embodiment of my invention, an elongated cast metal or metal injected molded, or other injected molded, tool body 100 has a central mounting block 110 for securing it in a driver. A non-cutting, wire seating end of the tool body 100 is designated as 120, while the wire seating and wire-engaging end of tool 100 is designated 130. In a manner well known in the art the wire seating end 120 may be used to seat a conductor wire in place against a connector block, prior to using the operative tool end 130 for inserting it between conductive knife blades. A central opening 12, square in the illustrated embodiment, is made through the tool end portion 130 for reasons of manufacturing convenience or to coincide with prior industry practice. The cast tool body or metal injected molded, or other injected molded body 100 is adapted to receive an impact from a power driver, as is well known in the art. The operative tool portion 130 has a locator opening 140 in its forward end. My replaceable cutting blade is designated as 150.

The operative tool portion 130 also has an elongated generally flat surface 10 for supporting my replaceable cutting blade 150. To the rear of central opening 12 a threaded screw hole 16 is provided, as part of the mechanism for fastening my removable cutting blade in place. A riser or locator pin 18 is formed forward of central opening 12 on the forward end portion of flat surface 10. Side flanges 14 and 15 are provided on the left and right sides of elongated flat surface 10 on its forward end portion and adjacent the locator pin 18.

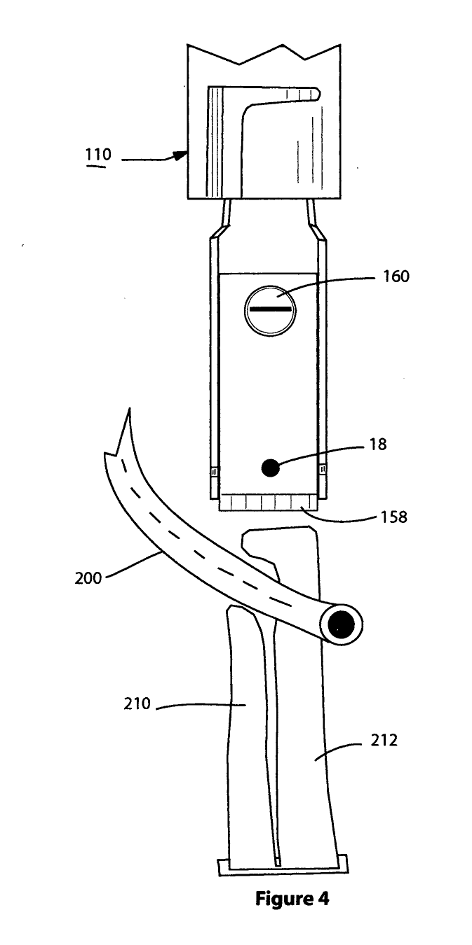

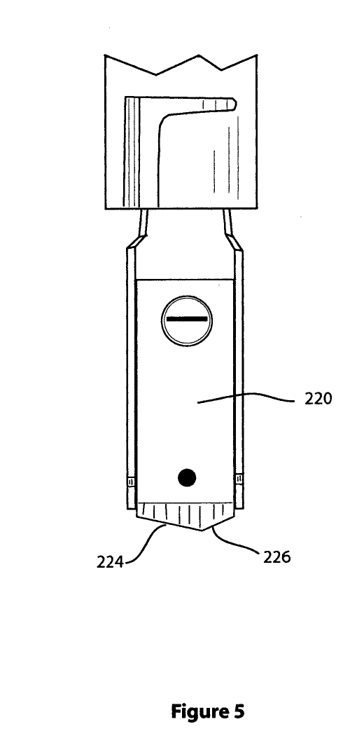

In the forward end portion 130 of tool member 100 the elongated locator opening 140 has a plane essentially parallel to the elongated flat surface 10. Opening 140 has side walls 142, 144, as shown in FIG. 3, and can partially encircle a pair of knife blades 210, 212 of a connector, as shown in FIGS. 4 and 5, in order to force an insulated conductor wire 200 to enter into the connector and conductively engage the connector blades.

My elongated essentially flat blade member 150 when supported on the elongated flat surface 10 of the metal body 100 is in essentially parallel relationship to the plane of the elongated locator opening 140. Blade member 150 has a forward end with a cutting edge 158 thereon which extends beyond the locator opening 140. Two separate fastening means secure the replaceable blade member at two different points along its length to the flat surface 10 of the elongated body 100.

For fastening the blade 150 to the tool body 120 the rearward end portion of blade 150 has an opening 152 formed therein. A threaded screw hole 16 in surface 10 located rearwardly of the opening 12 is adapted to receive a screw 160 passing through the hole or opening 152 to fasten the blade in place on tool 100. The locator pin or riser 18 formed on the forward end of flat surface 10 of the tool body engages another opening 155 in the forward end of blade member 150 to further support the blade.

On the forward end of flat surface 10 of the tool body 100 a pair of side flanges 14, 15, are formed. When blade 150 is secured in place by the screw 160 it is laterally positioned by the side flanges, as well as by the locator pin-18. My blade member is preferably manufactured according to Japanese Industrial Standard (JIS) with an Rc of 57 to 60. Alternatively, it can be made of a very hard insulating ceramic material.

### Alternate Forms

In an alternate form of my invention as shown in FIG. 5 the cutting end of the cutting blade 220 is sharpened from both of its lateral side edges with both a major cut 224 and a minor cut 226, thus making for a cleaner cutting action.

In another alternate form of my invention the section 120 of elongated body 100 may be omitted. The remaining portion of the tool may then be used as “no cut” when blade 150 has been removed or not yet attached.

Although the presently preferred forms of my invention have been disclosed herein, it will be understood that other modifications should be apparent to those skilled in the art, and that the scope of my invention is to be judged only by the appended claims.

### PARTS LIST

100 elongated tool body

110 central mounting block

120 non-cutting, wire seating end

130 wire seating and wire-engaging end

140 contact locator opening

10 elongated generally flat surface

12 with a central opening (square in this embodiment)

14, 15, side flanges on left and right sides of surface 10

16 threaded screw hole rearward of 12

18 riser or locator pin forward of opening 12

150 replaceable cutting blade

152 opening in blade rear end portion

155 opening in forward end portion of blade 150

158 sharp cutting edge of blade

160 screw to fasten blade 150 to surface 10

140 contact locator opening

200 conductor wire

210 left connector blade

212 connector right blade

220 alternate form of blade

224 major cut on blade 220

226 minor cut on blade 220

1. A termination tool for inserting the end of an insulated: wire between a pair of knife blades of an insulation displacing electrical connector of a circuit board, for securing the wire to the connector, and for then cutting off a protruding end portion of the wire, comprising:
an elongated metal body made of non-heat-treated cast metal, metal injected molded, or other injected molded body having an elongated generally flat surface for supporting a cutting blade, and a forward end portion with an elongated locator opening whose plane is essentially parallel to the elongated flat surface and that can partially encircle the pair of knife blades in order to force the insulated wire to enter into and conductively engage the connector;
an elongated essentially flat blade member supported on the elongated flat surface of the elongated body in essentially parallel relationship to the plane of the elongated locator opening, and having a forward end with a cutting edge thereon which extends beyond the locator opening;
two separate fastening means replaceably securing the blade member at two different points along its length to the flat surface of the elongated metal body; and
the blade member being made of tool grade steel, whereby the cutting edge of the blade member is sharper than if the blade member were formed integral with the elongated metal body.

2. A tool as in claim 1 wherein one of the fastening means includes a screw, passing through an opening in the blade member and into a threaded hole in the tool body; and the other fastening means includes a locator pin formed on the flat surface of the tool body and engaging an opening in the blade member.

3. A tool as in claim 2 wherein the replaceable blade has a rearward end portion and a forward end portion, the screw opening being formed in the rearward end portion of the blade and the opening to receive the locator pin being formed in the front end portion of the blade.

4. A tool as in claim 1 wherein a screw secures the rearward end portion of the blade member upon the tool body, an opening in the forward end portion of the blade member receives a locator pin formed on the forward front end portion of the blade, and a pair of side flanges formed on the forward end of the flat surface of the tool body laterally support the blade.

5. A termination tool responsive to an impact for inserting the end of an insulated wire into an insulation displacing type electrical connector, securing the wire to the connector, and then cutting off the protruding end portion of the wire, comprising:
a cast tool body having a mounting block portion for receiving an impact, and a positioning and cutting forward end portion which has an elongated flat surface and also has a locator opening in its forward end that can partially encircle an end of the connector;
a replaceable steel blade member having an essentially flat configuration, supported upon the elongated flat surface of the tool body in generally parallel relation to the locator opening, and having a cutting edge on its forward end that extends beyond the opening;
a threaded screw hole formed in the flat surface of the tool body at one point along its length, the blade member having an associated screw opening;
a screw passing through the screw opening to secure the blade member to the tool body; and
a locator pin formed at another point along the length of the flat surface of the tool body, the blade member having another opening to receive the locator pin.

6. A tool as in claim 5 wherein the replaceable blade member has the screw opening in its rearward end portion and the locator pin opening is in the forward end portion of the blade.

7. A termination tool as in claim 6 wherein the elongated tool body has a pair of side flanges on the forward end of the elongated flat surface of the wire-cutting portion, and the replaceable blade is received between those side flanges.

8. A termination tool as in claim 6 made by a process of forming the blade member from a material having characteristics significantly different than the elongated metal body, so that heat treating of the elongated metal body is not required and the cutting edge of the blade member can be made sharper than would have been possible if the blade were formed integral with the elongated metal body.

9. A termination tool as in claim 8 wherein the blade member is made according to Japanese Industrial Standard (JIS) with an Rc of 57 to 60.

10. In a 66 Blade impact tool for inserting the end of an insulated wire between a pair of knife blades of an insulation displacing electrical connector of a circuit board in order to secure the wire to the connector, and for then cutting off a protruding end portion of the wire, the improvement comprising:
an elongated tool body made of non-heat-treated cast metal, metal injected molded, or other injected molded body, having an elongated generally flat surface for supporting a cutting blade, and a forward end portion with an elongated locator opening that can partially encircle the pair of knife blades;
an elongated essentially flat blade member made of tool grade steel, being supported on the flat surface of the elongated body in essentially parallel relationship to the elongated locator opening, and having a forward end with a cutting edge thereon which extends beyond the locator opening;
a threaded screw hole in the flat surface of the tool body near its rearward end, a screw opening in the blade member, and a screw passing through the screw opening into the threaded screw hole to secure the blade member to the flat surface of the tool body; and
a locator pin formed on the flat surface near the forward end of the tool body and being seated in a corresponding opening in the blade member.

11. The invention of claim 10 wherein the cutting edge of the blade member is formed with both a major cut and a minor cut.
